(19) United States
(12) Patent Application Publication
(10) Pub. No.: US 2008/0070026 A1
(43) Pub. Date: Mar. 20, 2008

(54) HIGH HYDROXYETHYLATED STARCH AND HIGH DISPERSANT LEVELS IN GYPSUM WALLBOARD

(75) Inventors: Qiang Yu, Grayslake, IL (US); Sharon L. Tracy, Buffalo Grove, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: UNITED STATES GYPSUM COMPANY, Chicago, IL (US)

(21) Appl. No.: 11/932,211

(22) Filed: Oct. 31, 2007

Related U.S. Application Data
(63) Continuation-in-part of application No. 11/592,481, filed on Nov. 2, 2006.
Application No. 11/592,481 is a continuation-in-part of application No. 11/445,906, filed on Jun. 2, 2006.
Application No. 11/592,481 is a continuation-in-part of application No. 11/449,177, filed on Jun. 7, 2006.
(60) Provisional application No. 60/688,839, filed on Jun. 9, 2005.

(51) Int. Cl. B32B 3/00; C04B 9/00

(52) U.S. Cl. 428/312.4; 106/781

(57) ABSTRACT

The invention generally provides gypsum-containing slurries including stucco, a hydroxyethylated starch, naphthalenesulfonate dispersant, and sodium trimetaphosphate. The naphthalenesulfonate dispersant is present in an amount of about 0.1%-3.0% by weight based on the weight of dry stucco. The hydroxyethylated starch is present in an amount of from about 0.5% by weight to about 10% by weight based on the weight of dry stucco in the formulation. The sodium trimetaphosphate is present in an amount of about 0.1%-0.4% by weight based on the weight of dry stucco. Other slurry additives can include accelerators, binders, paper fiber, glass fiber, and other known ingredients. The invention also comprises the gypsum-containing products made with such slurries, for example, lightweight gypsum wallboard, and a method of making lightweight gypsum wallboard.

This application is a continuation-in-part of U.S. patent application Ser. No. 11/592,481, filed Nov. 2, 2006, which is a continuation-in-part of U.S. patent application Ser. No. 11/449,177, filed Jun. 7, 2006, and which also is a continuation-in-part of U.S. patent application Ser. No. 11/445,906, filed Jun. 2, 2006, each one of which claims the benefit of U.S. Provisional Application No. 60/688,839, filed Jun. 9, 2005. The entire disclosures of each of the foregoing patent applications are hereby incorporated by reference.

### FIELD OF THE INVENTION

This invention pertains to a method of making gypsum slurries containing a hydroxyethylated starch, a naphthalenesulfonate dispersant, and sodium trimetaphosphate, and products made therefrom. It also pertains to a method of increasing the dry strength of gypsum-containing products including wallboard by using a naphthalenesulfonate dispersant in combination with a hydroxyethylated starch and sodium trimetaphosphate in the slurry used to make the products.

### BACKGROUND OF THE INVENTION

Certain properties of gypsum (calcium sulfate dihydrate) make it very popular for use in making industrial and building products, such as gypsum wallboard. Gypsum is a plentiful and generally inexpensive raw material which, through a process of dehydration and rehydration, can be cast, molded or otherwise formed into useful shapes. The base material from which gypsum wallboard and other gypsum products are manufactured is the hemihydrate form of calcium sulfate (CaSO₄.½H₂O), commonly termed “stucco,” which is produced by heat conversion of the dihydrate form of calcium sulfate (CaSO₄.2H₂O), from which 1½ water molecules been removed.

Conventional gypsum-containing products such as gypsum wallboard have many advantages, such as low cost and easy workability, although substantial amounts of gypsum dust can be generated when the products are cut or drilled. Various improvements have been achieved in making gypsum-containing products using starches as ingredients in the slurries used to make such products. Pregelatinized starch, like glue, can increase flexural strength and compressive strength of gypsum-containing products including gypsum wallboard. Known gypsum wallboard contains starch at levels of less than about 10 lbs/MSF.

It is also necessary to use substantial amounts of water in gypsum slurries containing pregelatinized starch in order to ensure proper flowability of the slurry. Unfortunately, most of this water eventually must be driven off by drying, which is expensive due to the high cost of the fuels used in the drying process. This drying step is also time-consuming. It has been found that the use of naphthalenesulfonate dispersants can increase the fluidity of the slurries, thus overcoming the water demand problem. In addition, it has also been found that the naphthalenesulfonate dispersants, if the usage level is high enough, can cross-link to the pregelatinized starch to bind the gypsum crystals together after drying, thus increasing dry strength of the gypsum composite. Thus, the combination of the pregelatinized starch and the naphthalenesulfonate dispersant provide a glue-like effect in binding the set gypsum crystals together. Trimetaphosphate salts have not in the past been recognized to affect gypsum slurry water requirements. However, the present inventors have discovered that increasing the level of the trimetaphosphate salt to hitherto unknown levels in the presence of a specific dispersant makes it possible to achieve proper slurry flowability with unexpectedly reduced amounts of water, even in the presence of high starch levels. This, of course, is highly desirable because it in turn reduces fuel usage for drying as well as the process time associated with subsequent water removal process steps. Thus the present inventors have also discovered that the dry strength of gypsum board can be increased by using a naphthalenesulfonate dispersant in combination with pregelatinized starch in the slurry used to make the wallboard.

The gypsum wallboards of the instant invention should be distinguished from acoustical boards or tiles that do not have face sheets. Also, the wallboards of the instant invention should be distinguished from acoustical boards or tiles that include polystyrene as a lightweight aggregate. Importantly, the aforementioned acoustical boards and tiles do not meet many ASTM standards that apply to gypsum wallboards. For example, known acoustical boards do not have the flexural strength required of gypsum wallboards including those of the present invention. Conversely, in order for acoustical boards or tiles to meet ASTM standards, it is required that an exposed surface of the acoustical boards or tiles have hollow voids or depressions that would be undesirable in a gypsum wallboard, and would adversely effect nail pull resistance properties.

Dust generation is a potential problem during the installation of all wallboard. When gypsum wallboard is worked, for example, by cutting, sawing, routing, snapping, nailing or screwing down, or drilling, substantial amounts of gypsum dust can be generated. For the purposes of the instant disclosure, “dusting” and “dust generation” means the release of airborne dust into the surrounding workspace during working of a gypsum-containing product, by, for example, cutting, sawing, routing, score/snapping, nailing or screwing down, or drilling the wallboard. Working can also generally include normal board handling, including dust produced on accidentally scraping and gouging the boards during transport, carrying, and installation. If a way could be found to produce a low density wallboard in which such dust generation is significantly reduced, this would represent a particularly useful contribution to the art.

Pregelatinized starches can provide useful gypsum-containing slurries. One drawback of pregelatinized starch in comparison with regular acid-modified starch is higher water demand. Therefore, higher water-stucco ratios are required to make a slurry with pregelatinized starch that has a fluidity suitable for wallboard formation. Furthermore, if a way could be found to enhance fluidity in a particular gypsum-containing slurry including containing an alternative starch, a naphthalenesulfonate dispersant, and sodium trimetaphosphate, while maintaining adequate strength or improving strength in a finished gypsum wallboard, this would represent a useful contribution to the art.

### BRIEF SUMMARY OF THE INVENTION

The invention generally comprises a slurry including stucco, a hydroxyethylated starch, naphthalenesulfonate dispersant, and sodium trimetaphosphate. The naphthalenesulfonate dispersant is present in an amount of about 0.1%-3.0% by weight based on the weight of dry stucco. The hydroxyethylated starch is present in an amount of from about 0.5% by weight to about 10% by weight based on the weight of dry stucco in the formulation. The sodium trimetaphosphate is present in an amount of about 0.1%-0.4% by weight based on the weight of dry stucco. Other slurry additives can include accelerators, binders, paper or glass fibers and other known constituents. The invention also comprises the gypsum-containing products made with such slurries.

A preferred gypsum-containing product is gypsum wallboard. In this embodiment, the invention constitutes gypsum wallboard comprising a set gypsum composition formed between two substantially parallel cover sheets, the set gypsum composition made using the gypsum-containing slurry of water, stucco, a hydroxyethylated starch, a naphthalenesulfonate dispersant, and sodium trimetaphosphate. This gypsum wallboard made in accordance with the invention has unexpected high strength, yet much lower weight than conventional boards.

In another embodiment the invention constitutes a method of making gypsum wallboard by mixing a gypsum-containing slurry comprising water, stucco, a hydroxyethylated starch, naphthalenesulfonate dispersant, and sodium trimetaphosphate. wherein the hydroxyethylated starch is present in an amount of at least about 0.5% by weight up to about 10% by weight based on the weight of stucco. The resulting gypsum-containing slurry is deposited on a first paper cover sheet, and a second paper cover sheet is placed over the deposited slurry to form a gypsum wallboard. The gypsum wallboard is cut after the gypsum-containing slurry has hardened sufficiently for cutting, and the resulting gypsum wallboard is dried. Other conventional ingredients will also be used in the slurry including, as appropriate, accelerators, binders, paper fiber, glass fiber, and other known ingredients. A soap foam is normally added to reduce the density of the final gypsum wallboard product.

The invention generally comprises a low dusting gypsum wallboard including a set gypsum core formed between two substantially parallel cover sheets, the set gypsum core having a total void volume from about 75% to about 95%, the set gypsum core made from a gypsum-containing slurry comprising water, stucco, pregelatinized starch, and a naphthalenesulfonate dispersant, wherein the pregelatinized starch is present in an amount from about 0.5% by weight to about 10% by weight based on the weight of stucco. Preferably, the naphthalenesulfonate dispersant is present in an amount of about 0.1%-3.0% by weight based on the weight of dry stucco. Optionally, sodium trimetaphosphate is present in an amount of at least about 0.12% by weight based on the weight of stucco. In a preferred embodiment, the trimetaphosphate salt is present in an amount of about 0.12-0.4% by weight based on the weight of dry stucco.

In a preferred embodiment, the invention comprises low dusting gypsum wallboard comprising a set gypsum core including pregelatinized starch and a naphthalenesulfonate dispersant formed between two substantially parallel cover sheets, the set gypsum core having a total void volume from about 80% to about 92% wherein at least 60% of the total void volume comprises air voids having an average diameter less than about 100 microns, and the set gypsum core having a density from about 10 pcf to about 30 pcf. The term “pcf” is defined as pounds per cubic foot (lb/ft³). The set gypsum core is made from a gypsum-containing slurry comprising stucco, pregelatinized starch, and a naphthalenesulfonate dispersant, wherein the pregelatinized starch is present in an amount from about 0.5% by weight to about 10% by weight based on the weight of stucco. Preferably, the naphthalenesulfonate dispersant is present in an amount of about 0.1%-3.0% by weight based on the weight of dry stucco.

Gypsum wallboard made in accordance with the invention has high strength, yet much lower weight than conventional wallboards. In addition, it has been found that by insuring total core void volumes in the set gypsum core from about 75% to about 95%, and preferably from about 80% to about 92%, much less dust is generated on cutting, sawing, routing, snapping, nailing or screwing down, or drilling the wallboards made according to this embodiment.

In yet another embodiment the invention constitutes a method of making high strength, low dusting gypsum wallboard by mixing a gypsum-containing slurry comprising water, stucco, pregelatinized starch, and a naphthalenesulfonate dispersant, wherein the naphthalenesulfonate dispersant is present in an amount of about 0.1%-3.0% by weight based on the weight of dry stucco, wherein the pregelatinized starch is present in an amount of at least about 0.5% by weight up to about 10% by weight based on the weight of stucco, and adding sufficient soap foam to the gypsum-containing slurry to form a total void volume, including air voids, of from about 75% to about 95% in a finished wallboard. The resulting gypsum-containing slurry is deposited on a first paper or other appropriate cover sheet, and a second paper or other appropriate cover sheet is placed over the deposited slurry to form a gypsum wallboard. The gypsum wallboard is cut after the gypsum-containing slurry has hardened sufficiently for cutting, and the resulting gypsum wallboard is dried, to provide a set gypsum core in the finished wallboard with a total void volume, including air voids, from about 75% to about 95%. The gypsum-containing slurry can optionally contain a trimetaphosphate salt, for example, sodium trimetaphosphate. Other conventional ingredients will also be used in the slurry including, as appropriate, accelerators, binders, waterproofing agents, paper fiber, glass fiber, clay, biocide, and other known ingredients.

In yet another embodiment the invention constitutes a method of using low dusting gypsum wallboard by providing a low dusting gypsum wallboard with a set gypsum core having a total void volume from about 75% to about 95% wherein at least 60% of the total void volume comprises air voids having an average diameter less than about 100 microns and including water voids having an average diameter less than about 5 microns, working the wallboard in a manner that produces gypsum dust (e.g. cutting, sawing, routing, score/snapping, nailing or screwing down, or drilling); and capturing a substantial portion of the gypsum dust in the voids.

### DETAILED DESCRIPTION OF THE INVENTION

It has now unexpectedly been found hydroxyethylated starches have a lower water demand while enhancing fluidity in a gypsum-containing slurry. Furthermore, finished gypsum wallboards prepared from gypsum-containing slurries including water, stucco, a hydroxyethylated starch, naphthalenesulfonate dispersant, and sodium trimetaphosphate exhibit improved strength characteristics, particularly nail pull performance.

Hydroxyethylated starch, sometimes referred to as “ethylated starch,” must be used in gypsum-containing slurries prepared in accordance with the present invention. A preferred hydroxyethylated starch is S-Size 30 G, a modified corn starch available from PacMoore Products, Hammond, Ind., having the following typical analysis: moisture 10 to 13%, pH 5.0 to 7.5, particle size 95% through 100 mesh, specific gravity 1.50, molecular weight: greater than about 10,000, bulk density 35 pcf. See also Example 11.

Hydroxyethylated starch should be used in an amount of at least about 0.5% by weight up to about 10% by weight, based on the weight of dry stucco used in the gypsum-containing slurry. In a preferred embodiment, hydroxyethylated starch is used in an amount of about 3% by weight based on the weight of dry stucco.

Pregelatinized starch may be used in gypsum-containing slurries prepared in accordance with the present invention. A preferred pregelatinized starch is pregelatinized corn starch, for example pregelatinized corn flour available from Bunge Milling, St. Louis, Mo., having the following typical analysis: moisture 7.5%, protein 8.0%, oil 0.5%, crude fiber 0.5%, ash 0.3%; having a green strength of 0.48 psi; and having a loose bulk density of 35.0 lb/ft³. Pregelatinized corn starch should be used in an amount of at least about 0.5% by weight up to about 10% by weight, based on the weight of dry stucco used in the gypsum-containing slurry.

Enhanced fluidity in gypsum-containing slurries is related to lower viscosity. It has been found that a particular combination of a hydroxyethylated starch, naphthalenesulfonate dispersant, and sodium trimetaphosphate, used in a gypsum-containing slurry made according to the present invention, provides lower viscosity and better film-forming characteristics than slurries made with other starches. For example, in aqueous samples comprising pregelatinized starch, viscosities are relatively high, while producing films of good strength on cooking. In aqueous samples comprising hydroxyethylated starch and a dispersant, viscosities are lowered, while producing a film that is too flexible. In aqueous samples comprising hydroxyethylated starch, a dispersant, and sodium trimetaphosphate, viscosities are lowered, while producing a film that is strong, yet resilient. See Example 12.

Without intending to be bound by theory, the particular combination of a hydroxyethylated starch, naphthalenesulfonate dispersant, and sodium trimetaphosphate, used in a gypsum-containing slurry for production of a gypsum wallboard provides unexpectedly enhanced crosslinking to provide a more flexible, yet strong and resilient film, that produces far better nail pull properties and other strength characteristics than would otherwise have been predicted.

According to one embodiment of the present invention, there are provided finished gypsum-containing products made from gypsum-containing slurries containing stucco, a hydroxyethylated starch, naphthalenesulfonate dispersant, and sodium trimetaphosphate. The naphthalenesulfonate dispersant is present in an amount of about 0.1%-3.0% by weight based on the weight of dry stucco. The hydroxyethylated starch is present in an amount of from about 0.5% by weight to about 10% by weight based on the weight of dry stucco in the formulation. The sodium trimetaphosphate is present in an amount of about 0.1%-0.4% by weight based on the weight of dry stucco. Other ingredients that may be used in the slurry include binders, paper fiber, glass fiber, and accelerators. A soap foam is normally added to the newly formulated gypsum-containing slurries to reduce the density of the finished gypsum-containing product, for example, gypsum wallboard.

The present inventors have further discovered that an unexpected increase in dry strength (particularly in wallboard) can be obtained by using at least about 0.5% by weight up to about 10% by weight pregelatinized starch (preferably pregelatinized corn starch) in the presence of about 0.1% by weight to 3.0% by weight naphthalenesulfonate dispersant (starch and naphthalenesulfonate levels based on the weight of dry stucco present in the formulation). This unexpected result can be obtained whether or not water-soluble trimetaphosphate or polyphosphate is present.

In addition, it has unexpectedly been found that pregelatinized starch can be used at levels of at least about 10 lb/MSF, or more, in the dried gypsum wallboard made in accordance with the present invention, yet high strength and low weight can be achieved. Levels as high as 35-45 lb/MSF pregelatinized starch in the gypsum wallboard have been shown to be effective. As an example, Formulation B, as shown in Tables 1 and 2 below, includes 45 lb/MSF, yet produced a board weight of 1042 lb/MSF having excellent strength. In this example (Formulation B), a naphthalenesulfonate dispersant as a 45% by weight solution in water, was used at a level of 1.28% by weight.

A further unexpected result may be achieved with the present invention when the naphthalenesulfonate dispersant trimetaphosphate salt combination is combined with pregelatinized corn starch, and optionally, paper fiber or glass fiber. Gypsum wallboard made from formulations containing these three ingredients have increased strength and reduced weight, and are more economically desirable due to the reduced water requirements in their manufacture. Useful levels of paper fiber can range up to about 2% by weight based on the weight of dry stucco. Useful levels of glass fiber can range up to about 2% by weight based on the weight of dry stucco.

It has also unexpectedly been found that gypsum wallboard made using a gypsum-containing slurry including stucco, pregelatinized starch, and a naphthalenesulfonate dispersant, and an appropriate amount of soap foam, provides not only very low board core densities of about 10 to 30 pcf (and thus low board weight), but also low dusting upon normal board handling and upon working, such as, for example, cutting, sawing, routing, score/snapping, nailing or screwing down, or drilling, when the total void volume of the set gypsum core is from about 80% to about 92%. This wallboard is consequently easier to cut than other known products. The introduction of the soap foam produces small air (bubble) voids, which on average can be less than about 100 microns in diameter, but are generally greater than about 10 microns in diameter, and preferably greater than about 20 microns in diameter. The invention requires that these small air bubbles, along with evaporative water voids (generally about 5 microns in diameter, or less, normally less than about 2 microns in diameter), are generally evenly distributed throughout the set gypsum core in the finished wallboard products. For example, the set gypsum core can have a total void volume from about 80% to about 92% wherein at least 60% of the total void volume comprises air voids having an average diameter greater than about 10 microns and at least 10% of the total void volume comprises water voids having an average diameter less than about 5 microns. It is believed that the low density board core prepared in this manner with a total void volume of the set gypsum core from about 80% to about 92% as air and water voids (total core void volume) captures a substantial amount of the small dust and other debris in the voids exposed on cutting, sawing, routing, snapping, nailing or screwing down, or drilling the boards so that dust generation is significantly reduced and does not become air-borne.

The rehydration of calcium sulfate hemihydrate (stucco) and consequent hardening requires a specific, theoretical amount of water (1½ moles water/mole of stucco) to form calcium sulfate dihydrate crystals. However, the commercial process generally calls for excess water. This excess process water produces evaporative water voids in the gypsum crystal matrix which are generally substantially irregular in shape, and also are interconnected with other water voids, forming irregular channels in a generally continuous network between set gypsum crystals. In contrast, air (bubble) voids are introduced into the gypsum slurry using soap foam. The air voids are generally spherical round in shape, and also are generally separated from other air voids and thus generally discontinuous. The water voids can be distributed within the walls of the air voids (see, for example, FIGS. 8-10).

The effectiveness of dust capture depends upon the composition of the set gypsum core. It has been found that the naphthalenesulfonate dispersants, if the usage level is high enough, can cross-link to the pregelatinized starch to bind the gypsum crystals together after drying, thus increasing dry strength of the gypsum composite. Further, it has now unexpectedly been found that the combination of the pregelatinized starch and the naphthalenesulfonate dispersant (organic phase) provides a glue-like effect in binding the set gypsum crystals together, and when this formulation is combined with a particular void volume and void distribution, larger sized fragments are generated on score/snapping of the finished wallboard. Larger gypsum fragments generally produce less air-borne dust. In contrast, if a conventional wallboard formulation is used, smaller fragments are generated and thus more dust. For example, conventional wallboards can generate dust fragments on saw cutting having an average diameter of about 20-30 microns, and a minimum diameter of about 1 micron. In contrast, the gypsum wallboards of the present invention generate dust fragments on saw cutting having an average diameter of about 30-50 microns, and a minimum diameter of about 2 microns; score/snapping can produce even larger fragments.

In softer wallboards, dust can be captured in both the water voids and air voids (e.g. capture of small gypsum needles as single crystal dust). Harder wallboards favor dust capture in the air voids, since larger chunks or fragments of the set gypsum core are generated on working of these boards. In this case the dust fragments are too large for the water voids, but are trapped in the air voids. It is possible, according to one embodiment of the present invention, to achieve increased dust capture by introducing a preferred void/pore size distribution within the set gypsum core. It is preferred to have a distribution of small and large void sizes, as a distribution of air and water voids. In one embodiment, a preferred air void distribution can be prepared using soap foam. See Examples 6 and 7 below.

The ratio of air voids (greater than about 10 microns) to water voids (less than about 5 microns) within the set gypsum core can range from about 1.8:1 to about 9:1. A preferred ratio of air voids (greater than about 10 microns) to water voids (less than about 5 microns) within the set gypsum core can range from about 2:1 to about 3:1. In one embodiment, the void/pore size distribution within the set gypsum core should range from about 10-30% of voids less about 5 microns and from about 70-90% of voids greater than about 10 microns, as a percentage of total voids measured. Stated in another way, the ratio of air voids (greater than 10 microns) to water voids (less than 5 microns) within the set gypsum core ranges from about 2.3:1 to about 9:1. In a preferred embodiment, the void/pore size distribution within the set gypsum core should range from about 30-35% of voids less about 5 microns and from about 65-70% of voids greater than about 10 microns, as a percentage of total voids measured. Stated in another way, the ratio of air voids (greater than 10 microns) to water voids (less than 5 microns) within the set gypsum core ranges from about 1.8:1 to about 2.3:1.

It is preferred that the average air (bubble) void size be less than about 100 microns in diameter. In a preferred embodiment, the void/pore size distribution within the set gypsum core is: greater than about 100 microns (20%), from about 50 microns to about 100 microns (30%), and less than about 50 microns (50%). That is, a preferred median void/pore size is about 50 microns.

The air voids can reduce the bonding strength between a foamed low density set gypsum core and the cover sheets. Since greater than half of the composite gypsum boards by volume may consist of air voids due to foam, the foam can interfere with the bond between the foamed low density set gypsum core and the paper cover sheets. This is addressed by optionally providing a non-foamed (or reduced-foamed) bonding high density layer on the gypsum core-contacting surfaces of either the top cover sheet or the bottom cover sheet, or both the top cover sheet and the bottom cover sheet, prior to applying the cover sheets to the core. This non-foamed, or alternatively, reduced-foamed, bonding high density layer formulation typically will be the same as that of the gypsum slurry core formulation, except that either no soap will be added, or a substantially reduced amount of soap (foam) will be added. Optionally, in order to form this bonding layer, foam can be mechanically removed from the core formulation, or a different foam-free formulation can be applied at the foamed low density set gypsum core/face paper interface.

Soap foam is preferred to introduce and to control the air (bubble) void sizes and distribution in the set gypsum core, and to control the density of the set gypsum core. A preferred range of soap is from about 0.2 lb/MSF to about 0.7 lb/MSF; a more preferred level of soap is about 0.4 lb/MSF to about 0.5 lb/MSF.

Soap foam must be added in an amount effective to produce the desired densities, and in a controlled manner. In order to control the process, an operator must monitor the head of the board forming line, and keep the envelope filled. If the envelope is not kept filled, wallboards with hollow edges result, since the slurry cannot fill the necessary volume. The envelope volume is kept filled by increasing the soap usage to prevent rupture of air bubbles during manufacturing of the board (for better retaining the air bubbles), or by increasing the air foam rate. Thus, generally, the envelope volume is controlled and adjusted either by increasing or decreasing the soap usage, or by increasing or decreasing the air foam rate. The art of controlling the head includes adjustments to the “dynamic slurry” on the table by adding soap foam to increase slurry volume, or by decreasing soap foam usage to decrease slurry volume.

According to one embodiment of the present invention, there are provided finished gypsum-containing products made from gypsum-containing slurries containing stucco, pregelatinized starch, and a naphthalenesulfonate dispersant. The naphthalenesulfonate dispersant is present in an amount of about 0.1%-3.0% by weight based on the weight of dry stucco. The pregelatinized starch is present in an amount of at least about 0.5% by weight up to about 10% by weight based on the weight of dry stucco in the formulation. Other ingredients that may be used in the slurry include binders, waterproofing agents, paper fiber, glass fiber, clay, biocide, and accelerators. The present invention requires the addition of a soap foam to the newly formulated gypsum-containing slurries to reduce the density of the finished gypsum-containing product, for example, gypsum wallboard, and to control dusting by introduction of a total void volume of from about 75% to about 95%, and preferably from about 80% to about 92%, in the form of small air (bubble) voids and water voids in the set gypsum core. Preferably, the average pore size distribution will be from about 1 micron (water voids) to about 40-50 microns (air voids).

Optionally, the combination of from about 0.5% by weight up to about 10% by weight pregelatinized starch, from about 0.1% by weight up to about 3.0% by weight naphthalenesulfonate dispersant, and a minimum of at least about 0.12% by weight up to about 0.4% by weight of trimetaphosphate salt (all based on the weight of dry stucco used in the gypsum slurry) unexpectedly and significantly increases the fluidity of the gypsum slurry. This substantially reduces the amount of water required to produce a gypsum slurry with sufficient flowability to be used in making gypsum-containing products such as gypsum wallboard. The level of trimetaphosphate salt, which is at least about twice that of standard formulations (as sodium trimetaphosphate), is believed to boost the dispersant activity of the naphthalenesulfonate dispersant.

A naphthalenesulfonate dispersant must be used in gypsum-containing slurries prepared in accordance with the present invention. The naphthalenesulfonate dispersants used in the present invention include polynaphthalenesulfonic acid and its salts (polynaphthalenesulfonates) and derivatives, which are condensation products of naphthalenesulfonic acids and formaldehyde. Particularly desirable polynaphthalenesulfonates include sodium and calcium naphthalenesulfonate. The average molecular weight of the naphthalenesulfonates can range from about 3,000 to 27,000, although it is preferred that the molecular weight be about 8,000 to 22,000, and more preferred that the molecular weight be about 12,000 to 17,000. As a commercial product, a higher molecular weight dispersant has higher viscosity, and lower solids content, than a lower molecular weight dispersant. Useful naphthalenesulfonates include DILOFLO, DAXAD, and LOMAR D, available from GEO Specialty Chemicals, Lafayette, Ind. The naphthalenesulfonates are preferably used as aqueous solutions in the range 35-55% by weight solids content, for example. It is most preferred to use the naphthalenesulfonates in the form of an aqueous solution, for example, in the range of about 40-45% by weight solids content. Alternatively, where appropriate, the naphthalenesulfonates can be used in dry solid or powder form, such as LOMAR D, for example.

The polynaphthalenesulfonates useful in the present invention have the general structure (I): 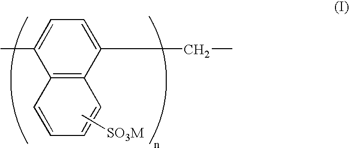
wherein n is >2, and wherein M is sodium, potassium, calcium, and the like.

The naphthalenesulfonate dispersant, preferably as an about 45% by weight solution in water, may be used in a range of from about 0.5% to about 3.0% by weight based on the weight of dry stucco used in the gypsum composite formulation. A more preferred range of naphthalenesulfonate dispersant is from about 0.5% to about 2.0% by weight based on the weight of dry stucco, and a most preferred range from about 0.7% to about 2.0% by weight based on the weight of dry stucco. In contrast, known gypsum wallboard contains this dispersant at levels of about 0.4% by weight, or less, based on the weight of dry stucco.

Stated in an another way, the naphthalenesulfonate dispersant, on a dry weight basis, may be used in a range from about 0.1% to about 1.5% by weight based of the weight of dry stucco used in the gypsum composite formulation. A more preferred range of naphthalenesulfonate dispersant, on a dry solids basis, is from about 0.25% to about 0.7% by weight based on the weight of dry stucco, and a most preferred range (on a dry solids basis) from about 0.3% to about 0.7% by weight based on the weight of dry stucco.

The gypsum-containing slurry can optionally contain a trimetaphosphate salt, for example, sodium trimetaphosphate. Any suitable water-soluble metaphosphate or polyphosphate can be used in accordance with the present invention. It is preferred that a trimetaphosphate salt be used, including double salts, that is trimetaphosphate salts having two cations. Particularly useful trimetaphosphate salts include sodium trimetaphosphate, potassium trimetaphosphate, calcium trimetaphosphate, sodium calcium trimetaphosphate, lithium trimetaphosphate, ammonium trimetaphosphate, and the like, or combinations thereof. A preferred trimetaphosphate salt is sodium trimetaphosphate. It is preferred to use the trimetaphosphate salt as an aqueous solution, for example, in the range of about 10-15% by weight solids content. Other cyclic or acyclic polyphosphates can also be used, as described in U.S. Pat. No. 6,409,825 to Yu et al., herein incorporated by reference.

Sodium trimetaphosphate is a known additive in gypsum-containing compositions, although it is generally used in a range of from about 0.05% to about 0.08% by weight based on the weight of dry stucco used in the gypsum slurry. In the embodiments of the present invention, sodium trimetaphosphate (or other water-soluble metaphosphate or polyphosphate) can be present in the range of from about 0.10% to about 0.4% by weight based on the weight of dry stucco used in the gypsum composite formulation. A preferred range of sodium trimetaphosphate (or other water-soluble metaphosphate or polyphosphate) is from about 0.12% to about 0.3% by weight based on the weight of dry stucco used in the gypsum composite formulation.

There are two forms of stucco, alpha and beta. These two types of stucco are produced by different means of calcination. In the present inventions either the beta or the alpha form of stucco may be used.

Accelerators can be used in the gypsum-containing compositions of the present invention, as described in U.S. Pat. No. 6,409,825 to Yu et al., herein incorporated by reference. One desirable heat resistant accelerator (HRA) can be made from the dry grinding of landplaster (calcium sulfate dihydrate). Small amounts of additives (normally about 5% by weight) such as sugar, dextrose, boric acid, and starch can be used to make this HRA. Sugar, or dextrose, is currently preferred. Another useful accelerator is “climate stabilized accelerator” or “climate stable accelerator,” (CSA) as described in U.S. Pat. No. 3,573,947, herein incorporated by reference.

Water/stucco (w/s) ratio, or “WSR” is an important parameter, since excess water must eventually be driven off by heating. In the embodiments of the present invention, a preferred w/s ratio is from about 0.7 to about 1.3. In a preferred embodiment, the w/s ratio is about 0.8.

Other gypsum slurry additives can include accelerators, binders, waterproofing agents, paper or glass fibers, clay, biocide, and other known constituents.

Cover sheets may be made of paper as in conventional gypsum wallboard, although other useful cover sheet materials known in the art (e.g. fibrous glass mats) may be used. Paper cover sheets provide strength characteristics in the gypsum wallboard. Useful cover sheet paper includes Manila 7-ply and News-Line 5-ply, available from United States Gypsum Corporation, Chicago, Ill.; Grey-Back 3-ply and Manila Ivory 3-ply, available from Caraustar, Newport, Ind.; and Manila heavy paper and MH Manila HT (high tensile) paper, available from United States Gypsum Corporation, Chicago, Ill. The paper cover sheets comprise top cover sheets, or face paper, and bottom cover sheets, or back paper. A preferred back cover sheet paper is 5-ply News-Line. Preferred face cover sheet papers include MH Manila HT (high tensile) paper and Manila 7-ply.

Fibrous mats may also be used as one or both of the cover sheets. One useful fibrous mat is a glass fiber mat in which filaments of glass fiber are bonded together by an adhesive. Preferably the fibrous mats will be nonwoven glass fiber mats in which filaments of glass fiber are bonded together by an adhesive. Most preferably, the nonwoven glass fiber mats will have a heavy resin coating. For example, Duraglass nonwoven glass fiber mats, available from Johns-Manville, having a weight of about 1.2-2.0 lb/100 ft², with about 40-50% of the mat weight coming from the resin coating, could be used. Other useful fibrous mats include, but are not limited to, woven glass mats and non-cellulosic fabrics.

The following examples further illustrate the invention. They should not be construed as in any way limiting the scope of the invention.

### EXAMPLE 1

### Sample Gypsum Slurry Formulations

Gypsum slurry formulations are shown in Table 1 below. All values in Table 1 are expressed as weight percent based on the weight of dry stucco. Values in parentheses are dry weight in pounds (lb/MSF).

TABLE 1

| Component | Formulation A | Formulation B |
|---|---|---|
| Stucco (lb/MSF) | (732) | (704) |
| sodium | 0.20 (1.50) | 0.30 (2.14) |
| trimetaphosphate | | |
| Dispersant | 0.18 (1.35) | 0.58¹ (4.05) |
| (naphthalenesulfonate) | | |
| Pregelatinized starch | 2.7 (20) | 6.4 (45) |
| (dry powder) | | |
| Board starch | 0.41 (3.0) | 0 |
| Heat resistant | (15) | (15) |
| accelerator (HRA) | | |
| Glass fiber | 0.27 (2.0) | 0.28 (2.0) |
| Paper fiber | 0 | 0.99 (7.0) |
| Soap* | 0.03 (0.192) | 0.03 (0.192) |
| Total Water (lb.) | 805 | 852 |
| Water/Stucco ratio | 1.10 | 1.21 |

*Used to pregenerate foam.
¹1.28% by weight as a 45% aqueous solution.

### EXAMPLE 2

### Preparation of Wallboards

Sample gypsum wallboards were prepared in accordance with U.S. Pat. Nos. 6,342,284 to Yu et al. and 6,632,550 to Yu et al., herein incorporated by reference. This includes the separate generation of foam and introduction of the foam into the slurry of all of the other ingredients as described in Example 5 of these patents.

Test results for gypsum wallboards made using the Formulations A and B of Example 1, and a normal control board are shown in Table 2 below. As in this example and other examples below, nail pull resistance, core hardness, and flexural strength tests were performed according to ASTM C-473. Additionally, it is noted that typical gypsum wallboard is approximately ½ inch thick and has a weight of between about 1600 to 1800 pounds per 1,000 square feet of material, or lb/MSF. (“MSF” is a standard abbreviation in the art for a thousand square feet; it is an area measurement for boxes, corrugated media and wallboard.)

TABLE 2

| | | Formulation A | Formulation |
|---|---|---|---|
| Lab test result | Control Board | Board | B Board |
| Board weight (lb/MSF) | 1587 | 1066 | 1042 |
| Nail pull resistance (lb) | 81.7 | 50.2 | 72.8 |
| Core hardness (lb) | 16.3 | 5.2 | 11.6 |
| Humidified bond load | 17.3 | 20.3 | 15.1 |
| (lb) | | | |
| Humidified bond | 0.6 | 5 | 11.1 |
| failure (%) | | | |
| Flexural strength, face- | 47 | 47.2 | 52.6 |
| up (MD) (lb) | | | |
| Flexural strength, face- | 51.5 | 66.7 | 78.8 |
| down (MD) (lb) | | | |
| Flexural strength, face- | 150 | 135.9 | 173.1 |
| up (XMD) (lb) | | | |
| Flexural strength, face- | 144.4 | 125.5 | 165.4 |
| down (XMD) (lb) | | | |

MD: machine direction
XMD: across machine direction

As illustrated in Table 2, gypsum wallboards prepared using the Formulation A and B slurries have significant reductions in weight compared to the control board. With reference again to Table 1, the comparisons of the Formulation A board to the Formulation B board are most striking. The water/stucco (w/s) ratios are similar in Formulation A and Formulation B. A significantly higher level of naphthalenesulfonate dispersant is also used in Formulation B. Also, in Formulation B substantially more pregelatinized starch was used, about 6% by weight, a greater than 100% increase over Formulation A accompanied by marked strength increases. Even so, the water demand to produce the required flowability remained low in the Formulation B slurry, the difference being about 10% in comparison to Formulation A. The low water demand in both Formulations is attributed to the synergistic effect of the combination of naphthalenesulfonate dispersant and sodium trimetaphosphate in the gypsum slurry, which increases the fluidity of the gypsum slurry, even in the presence of a substantially higher level of pregelatinized starch.

As illustrated in Table 2, the wallboard prepared using the Formulation B slurry has substantially increased strength compared with the wallboard prepared using the Formulation A slurry. By incorporating increased amounts of pregelatinized starch in combination with increased amounts of naphthalenesulfonate dispersant and sodium trimetaphosphate, nail pull resistance in the Formulation B board improved by 45% over the Formulation A board. Substantial increases in flexural strength were also observed in the Formulation B board as compared to the Formulation A board.

### EXAMPLE 3

### ½ Inch Gypsum Wallboard Weight Reduction Trials

Further gypsum wallboard examples (Boards C, D and E), including slurry formulations and test results are shown in Table 3 below. The slurry formulations of Table 3 include the major components of the slurries. Values in parentheses are expressed as weight percent based on the weight of dry stucco.

TABLE 3

| | | Formulation | Formulation | Formulation |
|---|---|---|---|---|
| | Control Board | C Board | D Board | E Board |
| Trial formulation | | | | |
| component/parameter | | | | |
| Dry stucco (lb/MSF) | 1300 | 1281 | 1196 | 1070 |
| Accelerator (lb/MSF) | 9.2 | 9.2 | 9.2 | 9.2 |
| DILOFLO¹ (lb/MSF) | 4.1 (0.32%) | 8.1 (0.63%) | 8.1 (0.68%) | 8.1 (0.76%) |
| Regular starch (lb/MSF) | 5.6 (0.43%) | 0 | 0 | 0 |
| Pregelatinized corn starch | 0 | 10 (0.78%) | 10 (0.84%) | 10 (0.93%) |
| (lb/MSF) | | | | |
| Sodium trimetaphosphate | 0.7 (0.05%) | 1.6 (0.12%) | 1.6 (0.13%) | 1.6 (0.15%) |
| (lb/MSF) | | | | |
| Total water/stucco ratio | 0.82 | 0.82 | 0.82 | 0.84 |
| (w/s) | | | | |
| Trial formulation | | | | |
| test results | | | | |
| Dry board weight | 1611 | 1570 | 1451 | 1320 |
| (lb/MSF) | | | | |
| Nail pull resistance (lb) | 77.3^{†} | 85.5 | 77.2 | 65.2 |

^{†}ASTM standard: 77 lb
¹DILOFLO is a 45% Naphthalensulfonate solution in water

As illustrated in Table 3, Boards C, D, and E were made from a slurry having substantially increased amounts of starch, DILOFLO dispersant, and sodium trimetaphosphate in comparison with the control board (about a two-fold increase on a percentage basis for the starch and dispersant, and a two- to three-fold increase for the trimetaphosphate), while maintaining the w/s ratio constant. Nevertheless, board weight was significantly reduced and strength as measured by nail pull resistance was not dramatically affected. Therefore, in this example of an embodiment of the invention, the new formulation (such as, for example, Board D) can provide increased starch formulated in a usable, flowable slurry, while maintaining the same w/s ratio and adequate strength.

### EXAMPLE 4

### Wet Gypsum Cube Strength Test

The wet cube strength tests were carried out by using Southard CKS board stucco, available from United States Gypsum Corp., Chicago, Ill. and tap water in the laboratory to determine their wet compressive strength. The following lab test procedure was used.

Stucco (1000 g), CSA (2 g), and tap water (1200 cc) at about 70° F. were used for each wet gypsum cube cast. Pregelatinized corn starch (20 g, 2.0% based on stucco wt.) and CSA (2 g, 0.2% based on stucco wt.) were thoroughly dry mixed first in a plastic bag with the stucco prior to mixing with a tap water solution containing both naphthalenesulfonate dispersant and sodium trimetaphosphate. The dispersant used was DILOFLO dispersant (1.0-2.0%, as indicated in Table 4). Varying amounts of sodium trimetaphosphate were used also as indicated in Table 4.

The dry ingredients and aqueous solution were initially combined in a laboratory Waring blender, the mixture produced allowed to soak for 10 sec, and then the mixture was mixed at low speed for 10 sec in order to make the slurry. The slurries thus formed were cast into three 2″×2″×2″ cube molds. The cast cubes were then removed from the molds, weighed, and sealed inside plastic bags to prevent moisture loss before the compressive strength test was performed. The compressive strength of the wet cubes was measured using an ATS machine and recorded as an average in pounds per square inch (psi). The results obtained were as follows:

TABLE 4

| | Sodium | | | |
|---|---|---|---|---|
| | trimetaphosphate, | DILOFLO¹ | Wet cube | |
| Test | grams | (wt % | weight | Wet cube |
| Sample | (wt % based | based on | (2″ × 2″ × 2″), | compressive |
| No. | on dry stucco) | dry stucco) | g | strength, psi |
| 1 | 0 | 1.5 | 183.57 | 321 |
| 2 | 0.5 (0.05) | 1.5 | 183.11 | 357 |
| 3 | 1 (0.1) | 1.5 | 183.19 | 360 |
| 4 | 2 (0.2) | 1.5 | 183.51 | 361 |
| 5 | 4 (0.4) | 1.5 | 183.65 | 381 |
| 6 | 10 (1.0) | 1.5 | 183.47 | 369 |
| 7 | 0 | 1.0 | 184.02 | 345 |
| 8 | 0.5 (0.05) | 1.0 | 183.66 | 349 |
| 9 | 1 (0.1) | 1.0 | 183.93 | 356 |
| 10 | 2 (0.2) | 1.0 | 182.67 | 366 |
| 11 | 4 (0.4) | 1.0 | 183.53 | 365 |
| 12 | 10 (1.0) | 1.0 | 183.48 | 341 |
| 13 | 0 | 2.0 | 183.33 | 345 |
| 14 | 0.5 (0.05) | 2.0 | 184.06 | 356 |
| 15 | 1 (0.1) | 2.0 | 184.3 | 363 |
| 16 | 2 (0.2) | 2.0 | 184.02 | 363 |
| 17 | 4 (0.4) | 2.0 | 183.5 | 368 |
| 18 | 10 (1.0) | 2.0 | 182.68 | 339 |

¹DILOFLO is a 45% Naphthalensulfonate solution in water

As illustrated in Table 4, Samples 4-5, 10-11, and 17, having levels of sodium trimetaphosphate in the about 0.12-0.4% range of the present invention generally provided superior wet cube compressive strength as compared to samples with sodium trimetaphosphate outside this range.

### EXAMPLE 5

### ½ Inch Light Weight Gypsum Wallboard Plant Production Trials

Further trials were performed (Trial Boards 1 and 2), including slurry formulations and test results are shown in Table 5 below. The slurry formulations of Table 5 include the major components of the slurries. Values in parentheses are expressed as weight percent based on the weight of dry stucco.

TABLE 5

| | | Plant | | Plant |
|---|---|---|---|---|
| | Control | Formulation | Control | Formulation |
| | Board 1 | Trial Board 1 | Board 2 | Trial Board 2 |
| Trial formulation | | | | |
| component/parameter | | | | |
| Dry stucco (lb/MSF) | 1308 | 1160 | 1212 | 1120 |
| DILOFLO¹ (lb/MSF) | 5.98 (0.457%) | 7.98 (0.688%) | 7.18 (0.592%) | 8.99 (0.803%) |
| Regular starch (lb/MSF) | 5.0 (0.38%) | 0 | 4.6 (0.38%) | 0 |
| Pregelatinized corn starch | 2.0 (0.15%) | 10 (0.86%) | 2.5 (0.21%) | 9.0 (0.80%) |
| (lb/MSF) | | | | |
| Sodium trimetaphosphate | 0.7 (0.05%) | 2.0 (0.17%) | 0.6 (0.05%) | 1.6 (0.14%) |
| (lb/MSF) | | | | |
| Total water/stucco ratio | 0.79 | 0.77 | 0.86 | 0.84 |
| (w/s) | | | | |
| Trial formulation | | | | |
| test results | | | | |
| Dry board weight | 1619 | 1456 | 1553 | 1443 |
| (lb/MSF) | | | | |
| Nail pull resistance (lb) | 81.5^{†} | 82.4 | 80.7 | 80.4 |
| Flexural strength, | 41.7 | 43.7 | 44.8 | 46.9 |
| average (MD) (lb) | | | | |
| Flexural strength, | 134.1 | 135.5 | 146 | 137.2 |
| average (XMD) (lb) | | | | |
| Humidified bond² load, | 19.2 | 17.7 | 20.9 | 19.1 |
| average (lb) | | | | |
| Humidified bond^{2,3} | 1.6 | 0.1 | 0.5 | 0 |
| failure (%) | | | | |

^{†}ASTM standard: 77 lb
MD: machine direction
XMD: across machine direction
¹DILOFLO is a 45% Naphthalensulfonate solution in water
²90° F./90% Relative Humidity
³It is well understood that under these test conditions, percentage failure rates <50% are acceptable.

As illustrated in Table 5, Trial Boards 1 and 2 were made from a slurry having substantially increased amounts of starch, DILOFLO dispersant, and sodium trimetaphosphate, while slightly decreasing the w/s ratio, in comparison with the control boards. Nevertheless, strength as measured by nail pull resistance and flexural testing was maintained or improved, and board weight was significantly reduced. Therefore, in this example of an embodiment of the invention, the new formulation (such as, for example, Trial Boards 1 and 2) can provide increased trimetaphosphate and starch formulated in a usable, flowable slurry, while maintaining substantially the same w/s ratio and adequate strength.

### EXAMPLE 6

### ½ Inch Ultra-Light Weight Gypsum Wallboard Plant Production Trials

Further trials were performed (Trial Boards 3 and 4) using Formulation B (Example 1) as in Example 2, except that the pregelatinized corn starch was prepared with water at 10% concentration (wet starch preparation) and a blend of HYONIC 25 AS and PFM 33 soaps (available from GEO Specialty Chemicals, Lafayette, Ind.) was used. For example, Trial Board 3 was prepared with a blend of HYONIC 25 AS and PFM 33 ranging from 65-70% by weight of 25AS, and the balance PFM 33. For example, Trial Board 4 was prepared with a 70/30 wt./wt. blend of HYONIC 25AS/HYONIC PFM 33. The trial results are shown in Table 6 below.

TABLE 6

| | Trial Board 3 | Trial Board 4 |
|---|---|---|
| | (Formulation B plus | (Formulation B plus |
| | HYONIC soap blend | HYONIC soap blend |
| | 65/35) | 70/30) |
| Lab test result | (n = 12) | (n = 34)* |
| Board weight (lb/MSF) | 1106 | 1013 |
| Nail pull resistance^{a} (lb) | 85.5 | 80.3 |
| Core hardness^{b} (lb) | >15 | 12.4 |
| Flexural strength, | 55.6 | 60.3¹ |
| average^{c} (MD) (lb) | | |
| Flexural strength, | 140.1 | 142.3¹ |
| average^{d} (XMD) (lb) | | |

*Except as marked.
¹n = 4
MD: machine direction
XMD: across machine direction
^{a}ASTM standard: 77 lb
^{b}ASTM standard: 11 lb
^{c}ASTM standard: 36 lb
^{d}ASTM standard: 107 lb

As illustrated in Table 6, strength characteristics as measured by nail pull and core hardness were above the ASTM standard. Flexural strength was also measured to be above the ASTM standard. Again, in this example of an embodiment of the invention, the new formulation (such as, for example, Trial Boards 3 and 4) can provide increased trimetaphosphate and starch formulated in a usable, flowable slurry, while maintaining adequate strength.

### EXAMPLE 7

### Percentage Void Volume Calculation in ½ Inch Thick Gypsum Wallboard Core as a Function of Board Weight and Saw Cutting Results

Further trials were performed in order to determine void volumes and densities (Trial Boards No. 5 to 13) using Formulation B (Example 1) as in Example 2, except that the pregelatinized corn starch was prepared with water at 10% concentration (wet starch preparation), 0.5% glass fiber was used, and naphthalenesulfonate (DILOFLO) was used at a level of 1.2% by weight as a 45% aqueous solution. Soap foam was made using a soap foam generator and introduced into the gypsum slurry in an amount effective to provide the desired densities. In the present example, soap was used at a level from 0.25 lb/MSF to 0.45 lb/MSF. That is, the soap foam usage was increased or decreased as appropriate. In each sample, the wallboard thickness was ½ inch, and the core volume was assumed to be uniform at 39.1 ft³/MSF. Void volumes were measured across 4 ft wide wallboard samples from which the front and back paper was removed. The front and back papers can have a thickness in the range 11-18 mil (each side). Void volumes/pore sizes and pore size distribution were determined by scanning electron microscopy and X-ray CT-scanning technology (XMT).

TABLE 7

| | | | Foam | | Evap. | Total | |
|---|---|---|---|---|---|---|---|
| | | Foam | Pore | Evaporative | Pore | Core | Board |
| Trial | Board | Void | Size | Void | Size | Void | Core |
| Board | Weight | Volume¹ | Distribution | Volume² | Distribution | Volume³ | Density |
| No. | (lb/MSF) | (ft³/MSF) | (%)^{†} | (ft³/MSF) | (%)^{†} | (%) | (pcf)⁴ |
| 5 | 1600-1700 | 15 | 54 | 12.7 | 46 | 70.8 | 39-41 |
| | (Control) | | | | | | |
| 6 | 1400 | 19.6 | 66 | 10.3 | 34 | 76.5 | 34 |
| 7 | 1300 | 21.1 | 69 | 9.4 | 31 | 78.0 | 31 |
| 8 | 1200 | 20.9 | 68 | 10.0 | 32 | 79.0 | 28 |
| 9 | 1100 | 21.1 | 67 | 10.4 | 33 | 80.6 | 26 |
| 10 | 1000 | 20.9 | 65 | 11.1 | 35 | 81.8 | 23 |
| 11 | 900 | 23.4 | 71 | 9.5 | 29 | 84.1 | 21 |
| 12 | 800 | 25.5 | 76 | 8.1 | 24 | 85.9 | 18 |
| 13 | 500 | 31.5 | 88 | 4.5 | 12 | 92.1 | 10 |

¹>10 micron air (bubble) voids
²<5 micron water voids
³Based on uniform core vol. = 39.1 ft³/MSF; i.e., Total core void volume = foam void vol. + evaporative void vol./39.1 × 100
⁴Based on uniform core vol. = 39.1 ft³/MSF; i.e., Board core density (pcf) = Board weight (lb/MSF) − weight of paper cover sheets (lb/MSF)/39.1 ft³/MSF = Board weight (lb/MSF) − 90 lb/MSF/39.1 ft³/MSF
^{†}Percent of total voids measured

As illustrated in Table 7, trial board samples having total core void volumes ranging from 79.0% to 92.1% were made, which correspond to board core densities ranging from 28 pcf down to 10 pcf, respectively. As an example, saw cutting of Trial board 10, having a total core void volume of 81.8% and a board core density of 23 pcf, generated about 30% less dust than control board. As an additional example, if wallboards with a conventional formulation having less binder (as starch with or without dispersant) were made that had significantly less that about 75-80% total core void volume, significantly greater dust generation would be expected on cutting, sawing, routing, snapping, nailing or screwing down, or drilling. For example, conventional wallboards can generate dust fragments on saw cutting having an average diameter of about 20-30 microns, and a minimum diameter of about 1 micron. In contrast, the gypsum wallboards of the present invention will generate dust fragments on saw cutting having an average diameter of about 30-50 microns, and a minimum diameter of about 2 microns; score/snapping will produce even larger fragments.

It has been shown that the combination of several key components used to make the gypsum-containing slurry, namely: stucco, naphthalenesulfonate dispersant, pregelatinized corn starch, sodium trimetaphosphate, and glass and/or paper fibers, in combination with a sufficient and effective amount of soap foam, can have a synergistic effect in producing a useful low density gypsum wallboard that also dramatically reduces gypsum dust formation during knife cutting, saw cutting, score/snapping, drilling, and normal board handling.

### EXAMPLE 8

### Dust Capture in Low Dust Gypsum Wallboard

If a wallboard were prepared according to the teachings of the present invention as in Example 7, it is expected that the gypsum dust produced on working the wallboard would comprise at least 50% by weight gypsum fragments larger than about 10 microns in diameter. At least about 30% or more of the total dust generated by working the wallboard by cutting, sawing, routing, score/snapping, nailing or screwing down, and drilling, would be captured.

### EXAMPLE 9

### Additional ½ Inch Light Weight Gypsum Wallboard Plant Production Trial Formulation

Further slurry formulations (Trial 14) were prepared as shown in Table 8 below. The slurry formulations of Table 8 include the major components of the slurries. Values in parentheses are expressed as weight percent based on the weight of dry stucco.

TABLE 8

| | Plant | |
|---|---|---|
| Trial formulation | Formulation | Control |
| component/parameter | Trial 14 | Formulation |
| Dry stucco (lb/MSF) | 925 | 925 |
| DILOFLO¹ (lb/MSF) | 14 (1.5%) | 14 (1.5%) |
| Hydroxyethylated starch | 26 (2.8%) | 0 |
| Pregelatinized corn starch | 0 | 26 (2.8%) |
| (lb/MSF) | | |
| Sodium trimetaphosphate | 2.78 (0.30%) | 2.78 (0.30%) |
| (lb/MSF) | | |
| Glass fiber (lb/MSF) | 2.0 (0.22%) | 2.0 (0.22%) |
| Heat resistant accelerator | 13 (1.4%) | 13 (1.4%) |
| (lb/MSF) | | |
| Soap blend² (lb/MSF) | 0.42 (0.045%) | 0.42 (0.045%) |
| Total water/stucco ratio | 0.76 | 0.88 |
| (w/s) | | |

¹DILOFLO is a 45% Naphthalensulfonate solution in water
²85/15 wt./wt. blend of HYONIC 25 AS and PFM 33 soaps. Note that during dynamic manufacturing process, the soap ratio can range from 70/30 upwards to a desired target range, e.g. from 70/30 to 80/20 to 85/15 or up to 90/10.

As shown in Table 8, Trial 14 slurry formulation had a significantly lower water demand, and significantly enhanced fluidity, in that the WSR was about 0.8. For the control formulation, required WSR ranged between 0.88 and 0.90. Therefore, water demand in the Trial 14 slurry composition is about 10% lower than a control slurry containing pregelatinized corn starch.

### EXAMPLE 10

### Additional ½ Inch Light Weight Gypsum Wallboard Plant Production Trials

Sample boards were made using the formulations of Example 9, and tested for strength characteristics.

TABLE 9

| | Plant | |
|---|---|---|
| | Formulation | Control |
| Trial formulation | Trial Board | Formulation |
| test results | 14 | Board |
| Dry board weight | 1211 | 1206 |
| (lb/MSF) | | |
| Nail pull resistance | 80.8 | 73.7 |
| (lb) | | |

As shown in Table 9, Trial 14 wallboards having hydroxyethylated starch have significantly enhanced nail pull performance.

### EXAMPLE 11

### Alkoxyl Analysis of Representative Starches

Starch samples as in Table 10 were tested for alkoxyl substitution of the cellulose backbone, using an Agilent GC-MS Model no. 6890N/5973I. Alkoxyl analysis was performed using the classical Zeisel reaction with the iodides from alkoxyl groups being determined by gas chromatography-mass spectroscopy.

TABLE 10

| | Integrated- | Area- | Counts 1- | iso- | |
|---|---|---|---|---|---|
| Sample | methoxyl | ethoxyl | propoxyl | propoxyl | toluene |
| Hydroxy- | 30680 | 492017 | 3773 | 5632 | 12826464 |
| ethylated | | | | | |
| corn starch | | | | | |
| Pregelatinized | 66856 | 16691 | 15623 | 8856 | 13228883 |
| corn starch | | | | | |
| LC-211 acid- | 64203 | 16166 | 21320 | 1493 | 13197117 |
| modified | | | | | |
| starch¹ | | | | | |

¹Available from ADM Company, Decatur, Illinois.

### EXAMPLE 12

### Viscosity Test Results and Film-Forming Tests

Aqueous samples were prepared for testing as shown in Table 11 as follows: the components were suspended in deionized water (250 g). Cooking was performed by heating on a conventional hot plate with magnetic stirring until a temperature of 240-247° F. was reached. After cooking, viscosity was measured as reported in Table 11. Next, a 20 g sample of cooked suspension in a weighing pan was dried overnight at 112-116° F. to form the test films of Table 11.

TABLE 11

| | | Uncooked | Cooked | |
|---|---|---|---|---|
| | | Suspension | Suspension | |
| Sam- | | Average | Average | |
| ple | Component amounts | Viscosity | Viscosity | Film Strength |
| No. | (g) | (cP)¹ | (cP)¹ | Characteristics |
| 1 | Hydroxyethylated | 7 | 29 | Softest and |
| | starch (16.6) | | | most flexible |
| 2 | Hydroxyethylated | 7 | 27 | Slightly harder |
| | starch (16.6) and | | | and slightly |
| | DAXAD dispersant² | | | less flexible |
| | (8.6) | | | |
| 3 | Hydroxyethylated | 7 | 28 | Slightly harder |
| | starch (16.6) and | | | and slightly |
| | STMP (1.6) | | | less flexible |
| 4 | Hydroxyethylated | 8 | 32 | Ideal |
| | starch (16.6), | | | combination of |
| | DAXAD dispersant² | | | hardness and |
| | (8.6), | | | flexibility |
| | and STMP (1.6) | | | |
| 5 | Pregelatinized corn | 34 | 38 | Very hard and |
| | starch (16.6) | | | less flexible |
| | | | | than above |
| | | | | samples |

STMP: sodium trimetaphosphate
¹Brookfield viscosity (spindle #2 @ 50 rpm)
²DAXAD is a 45% Naphthalenesulfonate solution in water

As shown in Table 11, sample 4 as an uncooked suspension shows outstanding 75% viscosity reduction compared to sample 5. In addition, sample 4 also has excellent film-forming characteristics in terms of hardness and flexibility. These film-forming characteristics produce a marked improvement in nail pull results in wallboard made using the noted combination of a hydroxyethylated starch, a naphthalenesulfonate dispersant, and sodium trimetaphosphate.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A lightweight high strength gypsum wallboard comprising:
a set gypsum composition formed between two substantially parallel cover sheets, the set gypsum composition made using a gypsum-containing slurry comprising:
water, stucco, a hydroxyethylated starch, a naphthalenesulfonate dispersant, and sodium trimetaphosphate, wherein the hydroxyethylated starch is present in an amount from about 0.5% by weight to about 10% by weight based on the weight of stucco, wherein the naphthalenesulfonate dispersant is present in an amount from about 0.1% to about 3.0% by weight based on the weight of stucco, and wherein the sodium trimetaphosphate is present in an amount of about 0.1% to about 0.4% by weight based on the weight of stucco.

2. The lightweight high strength gypsum wallboard of claim 1, wherein the naphthalenesulfonate dispersant is in the form of an aqueous solution containing about 40% to about 45% by weight naphthalenesulfonate and the aqueous solution is present in an amount from about 0.5% to about 2.5% by weight based on the weight of stucco.

3. The lightweight high strength gypsum wallboard of claim 1, wherein the hydroxyethylated starch is present in an amount of about 3% by weight based on the weight of stucco.

4. The lightweight high strength gypsum wallboard of claim 1, wherein the wallboard has a dry weight of about 1000 lb/MSF to about 1400 lb/MSF.

5. The lightweight high strength gypsum wallboard of claim 3, wherein the wallboard has a dry weight of about 1200 lb/MSF.

6. The lightweight high strength gypsum wallboard of claim 1, wherein the water/stucco ratio is about 0.8.

7. A gypsum-containing slurry comprising: water, stucco, a hydroxyethylated starch, a naphthalenesulfonate dispersant, and sodium trimetaphosphate, wherein the hydroxyethylated starch is present in an amount from about 0.5% by weight to about 10% by weight based on the weight of stucco, wherein the naphthalenesulfonate dispersant is present in an amount from about 0.1% to about 3.0% by weight based on the weight of stucco, and wherein the sodium trimetaphosphate is present in an amount of about 0.1% to about 0.4% by weight based on the weight of stucco.

8. The gypsum-containing slurry of claim 7, wherein the naphthalenesulfonate dispersant is present in an amount from about 0.5% to about 1.5% by weight based on the weight of stucco.

9. A gypsum-containing slurry comprising: water, stucco, a hydroxyethylated starch, and a naphthalenesulfonate dispersant, wherein the hydroxyethylated starch is present in an amount from about 0.5% by weight to about 10% by weight based on the weight of stucco, wherein the sodium trimetaphosphate is present in an amount of about 0.1% to about 0.4% by weight based on the weight of stucco, and wherein the naphthalenesulfonate dispersant is in the form of an aqueous solution containing about 40% to about 45% by weight naphthalenesulfonate and the aqueous solution is present in an amount from about 0.5% to about 3.0% by weight based on the weight of stucco.

10. The gypsum-containing slurry of claim 9, wherein the hydroxyethylated starch is present in an amount of about 3% by weight based on the weight of stucco, wherein the sodium trimetaphosphate is present in an amount of about 0.3% by weight based on the weight of stucco, and wherein the naphthalenesulfonate dispersant is in the form of an aqueous solution containing about 40% to about 45% by weight naphthalenesulfonate and the aqueous solution is present in an amount of about 1.5% by weight based on the weight of stucco.
